(19) United States
(12) Patent Application Publication
(10) Pub. No.: US 2016/0209765 A1
(43) Pub. Date: Jul. 21, 2016

(54) ELECTROPHOTOGRAPHIC PHOTOSENSITIVE MEMBER, PROCESS CARTRIDGE AND ELECTROPHOTOGRAPHIC APPARATUS, AND PHTHALOCYANINE CRYSTAL

(71) Applicant: CANON KABUSHIKI KAISHA, Ohta-ku, Tokyo (JP)

(72) Inventor: Masato Tanaka, Tagata-gun (JP)

(21) Appl. No.: 14/915,197

(22) PCT Filed: Aug. 21, 2014
(86) PCT No.: PCT/JP2014/072510

§ 371 Date: Feb. 26, 2016

(30) Foreign Application Priority Data
Aug. 28, 2013 (JP) 2013-176518
Jul. 16, 2014 (JP) 2014-146038

(51) Int. Cl. G03G 15/00

(52) U.S. Cl. CPC G03G 5/0696; G03G 5/047

(57) ABSTRACT

A photosensitive layer comprises: a phthalocyanine crystal in which a urea compound is contained. The urea compound has one or more urea moieties comprising: a carbonyl group, or a thiocarbonyl group, and two nitrogen atoms. Each of the two nitrogen atoms connects to a hydrogen atom, an alkyl group, an unsubstituted or substituted aryl group, or an unsubstituted or substituted arylene group. At least one of the nitrogen atoms connects to an unsubstituted or substituted aryl group.

### TECHNICAL FIELD

The present invention relates to an electrophotographic photosensitive member, a process cartridge and an electrophotographic apparatus each including the electrophotographic photosensitive member, and phthalocyanine crystal.

### BACKGROUND ART

Semiconductor lasers widely used as image exposure means in the field of electrophotography have a long lasing wavelength in the range of 650 to 820 nm. Thus, electrophotographic photosensitive members having sensitivity to such long-wavelength light are being developed.

Phthalocyanine pigments are effective charge-generating substances having high sensitivity to light in such a long-wavelength region. In particular, oxytitanium phthalocyanine and gallium phthalocyanine have excellent sensitivity characteristics, and oxytitanium phthalocyanine and gallium phthalocyanine of various crystal forms have been reported.

Although electrophotographic photosensitive members including phthalocyanine pigments have excellent sensitivity characteristics, generated photocarriers tend to remain in a photosensitive layer as memories that cause potential variations like a ghost phenomenon.

PTL 1 discloses that the addition of a particular organic electron acceptor in a process of acid pasting of a phthalocyanine pigment produces sensitization effects. However, the additive (the organic electron acceptor) may undergo a chemical change, and the transformation to the desired crystal form is sometimes difficult.

PTL 2 discloses that the electrophotographic characteristics are improved by wet-grinding a pigment and a particular organic electron acceptor and trapping the organic electron acceptor on a crystal surface simultaneously with crystal transformation.

PTL 3 discloses that the addition of a urea compound to a charge-generating layer containing a phthalocyanine pigment improves photosensitivity.

With the recent improvement in image quality, however, it is necessary to prevent image degradation due to ghost phenomena in various environments. As a result of investigations, the present inventors found that the techniques disclosed in PTL 2 and PTL 3 sometimes cannot sufficiently prevent image degradation due to ghost phenomena. In the method disclosed in PTL 2, the resulting phthalocyanine crystals do not sufficiently contain organic electron acceptors within the crystals, and most of the organic electron acceptors are only in a mixed state or are deposited on the surface of the crystals. Thus, there is room for improvement. In the method disclosed in PTL 3, the addition of a urea compound, which improves sensitization, also increases the number of photocarriers remaining in the charge-generating layer and thereby increases the likelihood of ghost phenomena.

### CITATION LIST

### Patent Literature

PTL 1 Japanese Patent Laid-Open No. 2001-40237

PTL 2 Japanese Patent Laid-Open No. 2006-72304

PTL 3 Japanese Patent Laid-Open No. 2-230254

### SUMMARY OF INVENTION

### Technical Problem

The present invention provides an electrophotographic photosensitive member that produces a smaller number of image defects due to ghost phenomena under severe conditions, such as in a low temperature and low humidity environment, as well as in a normal temperature and normal humidity environment, and a process cartridge and an electrophotographic apparatus each including the electrophotographic photosensitive member.

The present invention also provides phthalocyanine crystal in which a particular urea compound is contained.

### Solution to Problem

The present invention provides an electrophotographic photosensitive member comprising: a support; and a photosensitive layer formed on the support; wherein the photosensitive layer comprises: a phthalocyanine crystal in which a urea compound is contained, wherein the urea compound has one or more urea moieties comprising: a carbonyl group, or a thiocarbonyl group, and two nitrogen atoms, each of the two nitrogen atoms connects to a hydrogen atom, an alkyl group, an unsubstituted or substituted aryl group, or an unsubstituted or substituted arylene group, and at least one of the nitrogen atoms connects to an unsubstituted or substituted aryl group.

The present invention also provides a process cartridge detachably attachable to a main body of an electrophotographic apparatus, wherein the process cartridge integrally supports: the electrophotographic photosensitive member and at least one unit selected from the group consisting of a charging unit, a developing unit, a transferring device, and a cleaning unit.

The present invention provides an electrophotographic apparatus, comprising: the electrophotographic photosensitive member; a charging unit; an exposure unit; a developing unit; and a transferring unit.

The present invention provides a phthalocyanine crystal containing a urea compound within the crystal, wherein the urea compound has one or more urea moieties comprising: a carbonyl group, or a thiocarbonyl group, and two nitrogen atoms, each of the two nitrogen atoms connects to a hydrogen atom, an alkyl group, an unsubstituted or substituted aryl group, or an unsubstituted or substituted arylene group, and at least one of the nitrogen atoms connects to an unsubstituted or substituted aryl group.

The present invention provides an electrophotographic photosensitive member that produces a smaller number of image defects due to ghost phenomena under severe conditions, such as in a low temperature and low humidity environment, as well as in a normal temperature and normal humidity environment, and a process cartridge and an electrophotographic apparatus each including the electrophotographic photosensitive member.

The present invention also provides a phthalocyanine crystal that has excellent characteristics as a charge-generating substance.

Further features of the present invention will become apparent from the following description of exemplary embodiments with reference to the attached drawings.

### BRIEF DESCRIPTION OF DRAWINGS

FIG. 1 is a schematic view of an electrophotographic apparatus that includes a process cartridge including an electrophotographic photosensitive member.

FIG. 2 is an X-ray powder diffraction pattern of a hydroxygallium phthalocyanine crystal prepared in Example 1-1.

FIG. 3 is an X-ray powder diffraction pattern of a hydroxygallium phthalocyanine crystal prepared in Example 1-8.

FIG. 4 is an X-ray powder diffraction pattern of a hydroxygallium phthalocyanine crystal prepared in Comparative Example 1-1.

FIGS. 5A and 5B are schematic views of an example of a layered structure of an electrophotographic photosensitive member.

### DESCRIPTION OF EMBODIMENTS

An electrophotographic photosensitive member according to an embodiment of the present invention includes a support and a photosensitive layer formed on the support. The photosensitive layer contains a phthalocyanine crystal containing a urea compound within the crystal. The urea compound has one or more urea moieties that has a carbonyl group or a thiocarbonyl group and two nitrogen atoms. Each of the two nitrogen atoms connects to a hydrogen atom, an alkyl group, an unsubstituted or substituted aryl group, or an unsubstituted or substituted arylene group, and at least one of the nitrogen atoms connects to an unsubstituted or substituted aryl group.

The urea compound can be at least one selected from the group consisting of a compound represented by the following formula (I) and a compound represented by the following formula (2).

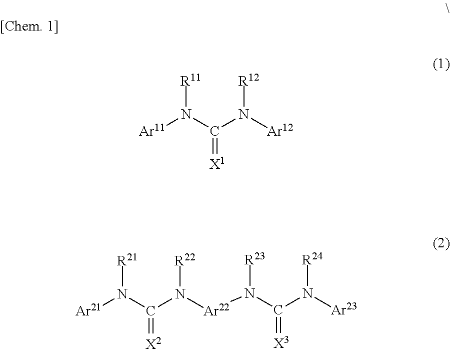

In the formulae (1) and (2), R¹¹, R¹², and R²¹ to R²⁴ each independently denote a hydrogen atom or an alkyl group. X¹ to X³ each independently denote an oxygen atom or a sulfur atom. Ar²² denotes an unsubstituted or substituted arylene group. Ar¹¹, Ar¹², Ar²¹, and Ar²³ each independently denote a hydrogen atom or an unsubstituted or substituted aryl group. At least one of Ar¹¹ and Ar¹² and at least one of Ar²¹ and Ar²³ each independently denote an unsubstituted or substituted aryl group.

A substituent of the substituted arylene group is an alkyl group, an alkoxy-substituted alkyl group, a halogen-substituted alkyl group, an alkoxy group, an alkoxy-substituted alkoxy group, a halogen-substituted alkoxy group, or a halogen atom.

A substituent of the substituted aryl group is a cyano group, a dialkylamino group, a hydroxy group, an alkyl group, an alkoxy-substituted alkyl group, a halogen-substituted alkyl group, an alkoxy group, an alkoxy-substituted alkoxy group, a halogen-substituted alkoxy group, a nitro group, or a halogen atom.

Ar²² in the formula (2) can be a phenylene group.

In the formulae (1) and (2), R¹¹, R¹², and R²¹ to R²⁴ can each independently denote a methyl group, an ethyl group, or a propyl group, or can denote a methyl group.

In the formulae (1) and (2), Ar¹¹, Ar¹², Ar²¹, and Ar²³ can each independently denote a substituted or unsubstituted phenyl group. A substituent of the substituted phenyl group may be an alkyl group, an alkoxy group, a dialkylamino group, or a halogen atom. A substituent of the substituted phenyl group may be a phenyl group.

Specific examples (exemplary compounds) of the urea compound and the melting points of the compounds are described below. The present invention is not limited to these compounds.

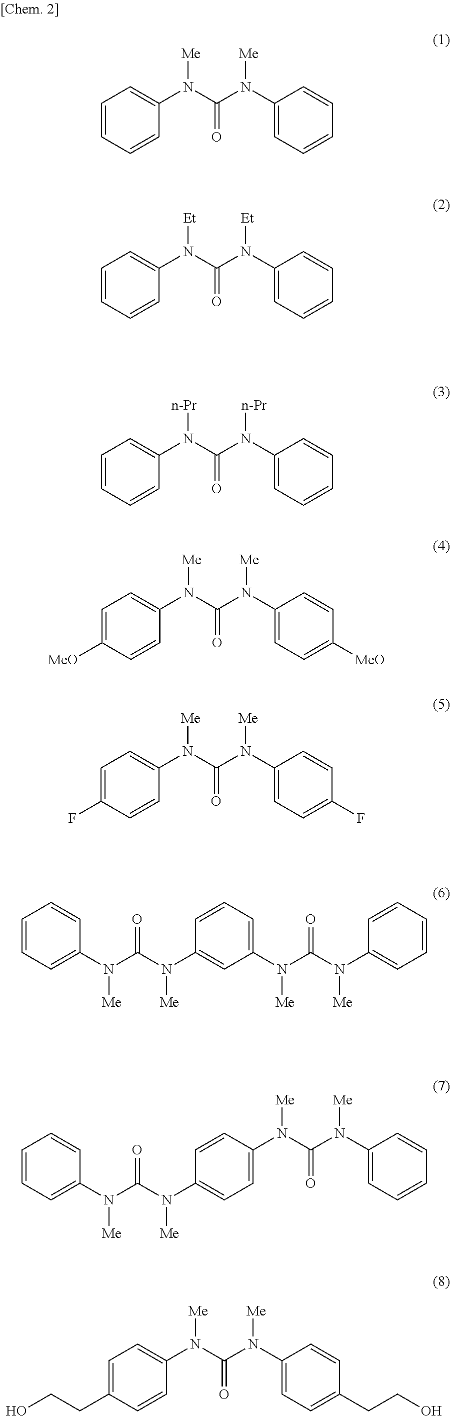

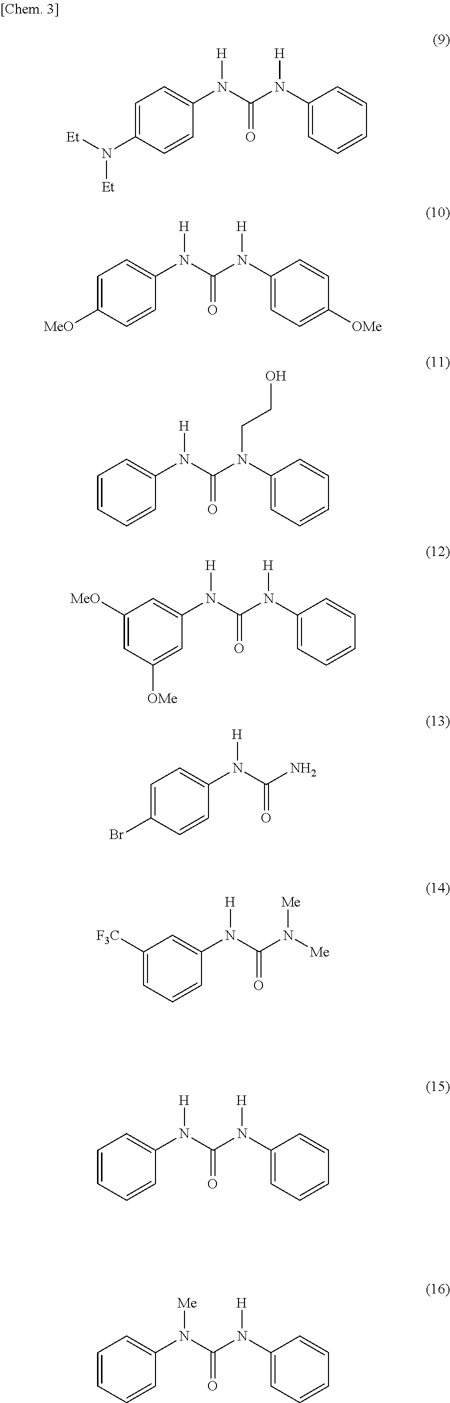

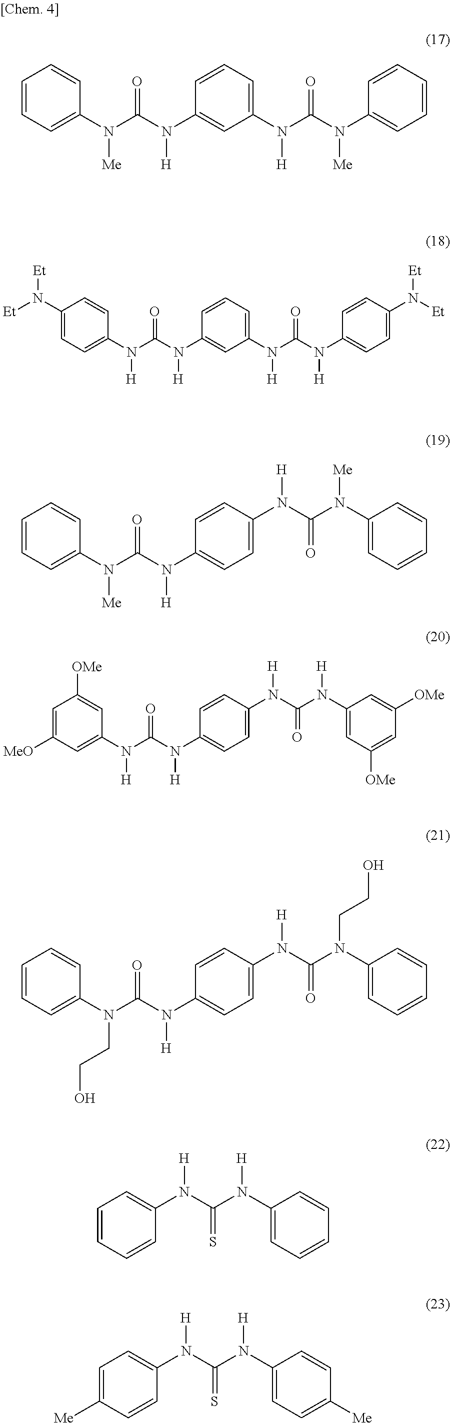

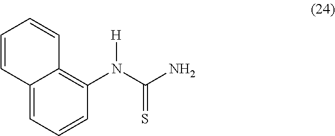 [SMILES: NC(=S)Nc1cccc2ccccc12]

TABLE 1

| Exemplary | Melting point |
|---|---|
| compound | (° C.) |
| (1) | 120 |
| (2) | 74 |
| (3) | 37 |
| (4) | 37 |
| (5) | 166 |
| (6) | 176 |
| (7) | 201 |
| (8) | 108 |
| (9) | 180 |
| (10) | 239 |
| (11) | 82 |
| (12) | 169 |
| (13) | 227 |
| (14) | 162 |
| (15) | 242 |
| (16) | 100 |
| (17) | 130 |
| (18) | 221 |
| (19) | 231 |
| (20) | 304 |
| (21) | 193 |
| (22) | 151 |
| (23) | 179 |
| (24) | 191 |

In these exemplary compounds, Me denotes a methyl group, Et denotes an ethyl group, and n-Pr denotes a propyl group (n-propyl group). The melting points of the exemplary compounds are melting points in a normal temperature and pressure (20° C., 1 atm) environment. The physical state (20° C.) of the exemplary compounds is solid.

Production examples of a urea compound according to an embodiment of the present invention will be described below.

The urea compound is produced by the addition reaction of an arylamine derivative and a phenyl isocyanate derivative or a phenylene diisocyanate derivative. NH of a urea moiety of the resulting urea compound is N-alkylated.

In the production examples, “%” represents “% by mass”, and “part” represents “part by mass”. Mass spectrometry was performed with a Trace DSQ-MASS spectrometer (manufactured by Thermo Electron Co., Ltd.). Infrared spectroscopy (IR) measurements were performed with FT/IR-420 (manufactured by JASCO Corp.). A nuclear magnetic resonance (NMR) spectrum was measured with R-90 (manufactured by Hitachi, Ltd.).

### Production Example 1

### Production of Exemplary Compound (19)

In a three-necked flask, 50.2 parts of N-methylaniline was dissolved in 300 parts of tetrahydrofuran. A solution of 15 parts of 1,4-phenylene diisocyanate dissolved in 150 parts of tetrahydrofuran was slowly added dropwise to the flask. The mixture was refluxed for 20 hours while stirring. Hot precipitated crystals were filtered and were sufficiently washed with tetrahydrofuran, yielding 32.8 parts of an exemplary compound (19) as white crystals. The following are characteristic peaks of the IR spectrum and NMR data of the product.

IR (cm⁻¹, KBr): 3368, 3068, 1646, 1549, 1303, 1230, 824, 698

¹H-NMR (puff, DMSO-d6): δ=7.75 (s, 2H, NH) 7.40 (t, 4H) 7.30 (d, 4H, J=8.3 Hz) 7.24 (s, 4H) 7.23 (t, 2H) 3.25 (s, 6H, N—CH3)

### Production Example 2

### Production of Exemplary Compound (7)

In a nitrogen atmosphere in a three-necked flask, 6.9 parts of 60% sodium hydride and 560 parts of dry N,N-dimethylformamide were cooled to 10° C. 28.0 parts of the exemplary compound (19) prepared in the production example 1 was slowly added to the flask. After the addition, the mixture was stirred for 30 minutes and was then cooled to 0° C. 25.5 parts of methyl iodide was slowly added to the liquid mixture. The liquid mixture was then stirred at room temperature for one hour. 1700 parts of water was added to the reaction solution. The resulting precipitate was filtered off and was sufficiently washed with water. The precipitate was recrystallized in tetrahydrofuran, yielding a 26.6 parts of an exemplary compound (7) as light-cream-colored crystals. The following are characteristic peaks of the IR spectrum and NMR data of the product.

IR (cm⁻¹, KBr): 2891, 1638, 1355, 704, 565

¹H-NMR (ppm, DMSO-d6): δ=7.12 (t, 4H) 6.96 (t, 2H, J=7.3 Hz) 6.90 (d, 4H, J=7.3 Hz) 6.70 (s, 4H) 2.99 (s, 6H, N—CH3) 2.98 (s, 6H, N—CH3)

### Production Example 3

### Production of Exemplary Compound (17)

In a three-necked flask, 33.5 parts of N-methylaniline was dissolved in 240 parts of tetrahydrofuran. A solution of 10.3 parts of 1,3-phenylene diisocyanate dissolved in 60 parts of tetrahydrofuran was slowly added dropwise to the flask. The mixture was refluxed for 7 hours while stirring. The reaction solution was concentrated. The resulting viscous liquid was dissolved in 160 parts of ethyl acetate and was dispersed and washed with 1 N aqueous hydrochloric acid and then with water three times. The ethyl acetate phase was dried over magnesium sulfate and was concentrated to yield 23.5 parts of an exemplary compound (17) as pale yellow crystals. The following are characteristic peaks of the IR spectrum and NMR data of the product.

IR (cm⁻¹ KBr): 3428, 3314, 1673, 1530, 1342, 700

¹H-NMR (ppm, CDCl3): δ=7.6 to 6.8 (m, 14H, Ar—H) 6.19 (ors, 2H, NH) 3.30 (s, 6H, N—CH3).

### Production Example 4

### Production of Exemplary Compound (6)

In a nitrogen atmosphere in a three-necked flask, 3.2 parts of 60% sodium hydride and 130 parts of N,N-dimethylformamide were cooled to 10° C. 13.1 parts of the exemplary compound (17) prepared in the production example 3 was slowly added to the flask. After the addition, the mixture was stirred for 30 minutes and was then cooled to 0° C. 11.9 parts of methyl iodide was slowly added to the liquid mixture. The liquid mixture was then stirred at room temperature for two hours. 450 parts of water was added to the reaction solution. The resulting precipitate was filtered off and was sufficiently washed with water. The precipitate was recrystallized in toluene, yielding a 11.0 parts of an exemplary compound (6) as white crystals. The following are characteristic peaks of the IR spectrum and NMR data of the product.

IR (cm⁻¹, KBr): 3064, 1658, 1496, 1356, 766, 701

¹H-NMR (ppm, CDCl3): δ=6.0 to 7.2 (m, 14H, Ar—H) 3.13 (s, 6H, N—CH3) 2.97 (s, 6H, N—CH3)

Examples of phthalocyanine that forms a phthalocyanine crystal containing a urea compound within the crystal include metal-free phthalocyanine and metal phthalocyanine having an axial ligand. These phthalocyanines may have a substituent. Oxytitanium phthalocyanine and gallium phthalocyanine tend to produce ghosts but have excellent sensitivity.

Examples of gallium phthalocyanine that forms gallium phthalocyanine crystals include those in which a halogen atom, a hydroxy group, or an alkoxy group coordinates as an axial ligand to a gallium atom of a gallium phthalocyanine molecule. The phthalocyanine ring may have a substituent, such as a halogen atom.

The gallium phthalocyanine crystal can contain N,N-dimethylformamide and/or N-methylformamide within the crystal.

The gallium phthalocyanine crystal can be a hydroxygallium phthalocyanine crystal, a bromogallium phthalocyanine crystal, or an iodogallium phthalocyanine crystal, which has excellent sensitivity. The gallium phthalocyanine crystal can be a hydroxygallium phthalocyanine crystal. In hydroxygallium phthalocyanine crystals, a hydroxy group coordinates as an axial ligand to the gallium atom. In bromogallium phthalocyanine crystals, a bromine atom coordinates as an axial ligand to the gallium atom. In iodogallium phthalocyanine crystals, an iodine atom coordinates as an axial ligand to the gallium atom.

In order to prevent image defects due to ghost phenomena, the hydroxygallium phthalocyanine crystal can be a hydroxygallium phthalocyanine crystal having peaks at Bragg angles 2θ of 7.4±0.3 degrees and 28.3±0.3 degrees in X-ray diffraction using CuKα radiation

The urea compound content of the phthalocyanine crystal can be 0.01 mass % of more and 3 mass % or less.

The term “a phthalocyanine crystal in which a urea compound is contained” means that the urea compound is incorporated into the crystal.

A method for producing a phthalocyanine crystal containing a urea compound within the crystal will be described below. A phthalocyanine crystal containing a urea compound within the crystal is produced using a crystal transformation process by mixing a phthalocyanine produced by acid pasting with a solvent and then with a urea compound and subjecting the mixture to wet milling.

The milling may be performed with a mill, such as a sand mill or a ball mill, using glass beads, steel beads, or alumina balls as a dispersant. The milling time can range from approximately 5 to 100 hours. A sample can be taken at intervals in the range of 5 to 10 hours, and the Bragg angle of the crystal can be measured. The amount of dispersant used in the milling can range from 10 to 50 parts by mass per part by mass of the phthalocyanine. Examples of the solvent include amide solvents, such as N,N-dimethylformamide, N,N-dimethylacetamide, N-methylformamide, N-methylacetamide, N-methylpropionamide, and N-methyl-2-pyrrolidone, halogen solvents, such as chloroform, ether solvents, such as tetrahydrofuran, and sulfoxide solvents, such as dimethyl sulfoxide. The amount of solvent to be added can range from 5 to 30 parts by mass per part by mass of the phthalocyanine. The amount of urea compound to be added can range from 0.1 to 30 parts by mass per part by mass of the phthalocyanine.

Whether a phthalocyanine crystal contains a urea compound within the crystal can be determined by analyzing NMR measurement data and thermogravimetry (TG) measurement data of the phthalocyanine crystal.

In the case of milling with a solvent that can dissolve a urea compound or in the case of a cleaning process after milling with a cleaning solvent that can dissolve a urea compound, the resulting phthalocyanine crystal is subjected to a NMR measurement. In the case where a urea compound is detected in the phthalocyanine crystal, it can be judged that the urea compound is contained within the crystal.

When a urea compound is insoluble in a solvent for milling and a cleaning solvent, after milling, the phthalocyanine crystal is subjected to a NMR measurement. When the urea compound is detected, the phthalocyanine crystal is subjected to the following method.

A phthalocyanine crystal produced by the addition of the area compound in milling, a phthalocyanine crystal produced in the same manner except that no urea compound is added in milling and the urea compound alone are independently subjected to TG measurements. In the case where the TG measurement of the phthalocyanine crystal produced by the addition of the urea compound is considered to be a combination of the TG measurement of the phthalocyanine crystal produced without urea compound and the TG measurement of the urea compound at a certain ratio, the phthalocyanine crystal produced by the addition of the urea compound can be considered to be a mixture of the phthalocyanine crystal and the urea compound or the phthalocyanine crystal on which the urea compound is deposited.

In the case where the weight loss in the TG measurement of the phthalocyanine crystal produced by the addition of the urea compound is greater than the weight loss in the TG measurement of the phthalocyanine crystal produced without urea compound at temperatures higher than the temperature at which the weight loss of the urea compound alone is completed, it can be judged that the urea compound is contained within the crystal.

The TG measurement, X-ray diffraction, and NMR measurement of a phthalocyanine crystal according to an embodiment of the present invention were performed under the following conditions.

[TG Measurement] Measuring instrument: TG/DTA simultaneous measurement apparatus manufactured by Seiko Instruments Inc. (trade name: TG/DTA 220U)

Atmosphere: nitrogen stream (300 cm³/min)

Measurement range: 35° C. to 600° C.

Heating rate: 10° C./min

[X-Ray Powder Diffraction Measurement] Measuring instrument: X-ray diffractometer RINT-TTR II manufactured by Rigaku Corp.

X-ray tube: Cu

Tube voltage: 50 kV

Tube current: 300 mA.

Scanning method: 2θ/θ scan

Scan speed: 4.0 degrees/minute

Sampling intervals: 0.02 degrees

Start angle (2θ): 5.0 degrees

Stop angle (2θ): 40.0 degrees

Attachment: standard sample holder

Filter: not used

Incident monochromator: used

Counter monochromator: not used

Divergence slit: open

Divergence height-limiting slit: 10.00 mm

Scattering slit: open

Light receiving slit: open

Flat monochromator: used

Counter: scintillation counter

[NMF Measurement] Measuring instrument: AVANCE III 500 manufactured by Broker Corp.

Solvent: deuterated sulfuric acid (D₂SO₄)

A phthalocyanine crystal containing a urea compound within the crystal functions as a good photoconductor and can be applied to solar cells, sensors, and switching elements, as well as electrophotographic photosensitive members.

A phthalocyanine crystal containing a urea compound within the crystal used as a charge-generating substance in an electrophotographic photosensitive member will be described below.

An electrophotographic photosensitive member according to an embodiment of the present invention includes a support and a photosensitive layer formed on the support. A photosensitive layer may be a monolayer photosensitive layer, which contains a charge-generating substance and a charge-transport substance, or a multilayer photosensitive layer, which is composed of a charge-generating layer containing a charge-generating substance and a charge-transport layer containing a charge-transport substance. The multilayer photosensitive layer can include a charge-generating layer and a charge-transport layer formed on the charge-generating layer.

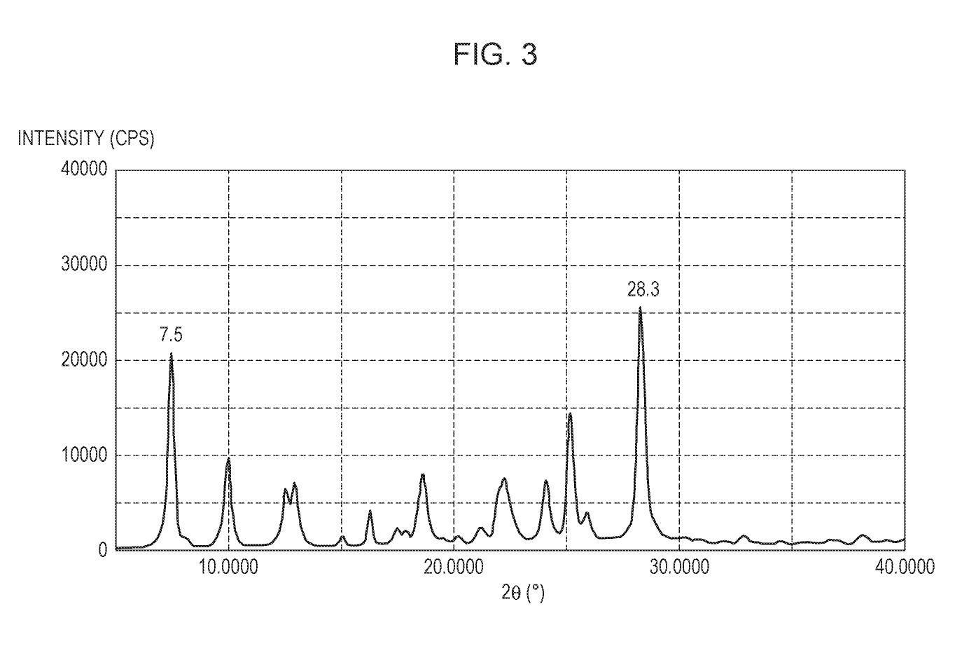

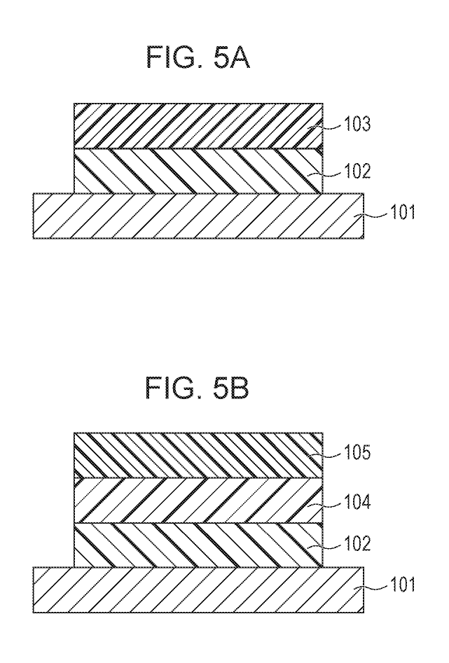

FIGS. 3A and 5B illustrate layered structures of an electrophotographic photosensitive member according to an embodiment of the present invention. In FIGS. 5A and 5B, the reference numeral 101 denotes a support, 102 denotes an undercoat layer, 103 denotes a photosensitive layer, 104 denotes a charge-generating layer, and 105 denotes a charge-transport layer.

[Support] The support can be conductive (a conductive support). Examples of the support include, but are not limited to, supports made of metals, such as aluminum, aluminum alloys, copper, zinc, stainless steel, vanadium, molybdenum, chromium, titanium, nickel, indium, gold, and platinum. The support may also be a resin support that includes a layer on which an aluminum, aluminum alloy, indium oxide, tin oxide, or indium oxide-tin oxide alloy film is formed by vacuum evaporation. The support may also be a plastic or paper support containing conductive particles or a plastic support containing a conductive polymer. In order to prevent interference fringes due to the scattering of a laser beam, the surface of the support may be subjected to cutting, surface roughening, alumite treatment, electrochemical mechanical polishing, wet honing, or dry honing.

A conductive layer for preventing interference fringes caused by laser beam scattering or for covering (coating) scratches of the support may be disposed between the support and the undercoat layer described below. The conductive layer can be formed by applying a coating liquid for the conductive layer to form a coating film and drying the coating film. The coating liquid for the conductive layer can be prepared by dispersing conductive particles, such as carbon black, metal particles, or metal oxide particles, and a binder resin in a solvent.

Examples of the conductive particles include, but are not limited to, aluminum particles, titanium oxide particles, tin oxide particles, zinc oxide particles, carbon black, and silver particles. Examples of the binder resin include, but are not limited to, polyesters, polycarbonates, poly(vinyl butyral), acrylic resins, silicone resins, epoxy resins, melamine resins, urethane resins, phenolic resins, and alkyd resins. Examples of the solvent of the coating liquid for the conductive layer include, but are not limited to, ether solvents, alcohol solvents, ketone solvents, and aromatic hydrocarbon solvents.

An undercoat layer having a barrier function and an adhesive function (also referred to as a barrier layer or an intermediate layer) may be disposed between the support and the photosensitive layer. The undercoat layer can be formed by applying a coating liquid for the undercoat layer to form a coating film and drying the coating film. The coating liquid for the undercoat layer can be prepared by mixing a binder resin and a solvent.

Examples of the binder resin include, but are not limited to, poly(vinyl alcohol), poly(ethylene oxide), ethylcellulose, methylcellulose, casein, polyamides (such as nylon 6, nylon 66, nylon 610, copolymerized nylon, and N-alkoxymethylated nylons), polyurethanes, acrylic resins, allyl resins, alkyd resins, and epoxy resins. The undercoat layer preferably has a thickness in the range of 0.1 to 10 μm, more preferably 0.5 to 5 μm. Examples of the solvent of the coating liquid for the undercoat layer include, but are not limited to, ether solvents, alcohol solvents, ketone solvents, and aromatic hydrocarbon solvents.

[Photosensitive Layer] The monolayer photosensitive layer can be formed by applying a coating liquid to form a coating film and drying the coating film. The coating liquid can be prepared by mixing a charge-generating substance, which is a phthalocyanine crystal containing a urea compound within the crystal, a charge-transport substance, and a binder resin in a solvent.

The charge-generating layer of the multilayer photosensitive layer can be formed by applying a coating liquid for the charge-generating layer to form a coating film and drying the coating film. The coating liquid for the charge-generating layer can be prepared by mixing a charge-generating substance, which is a phthalocyanine crystal containing a urea compound within the crystal, and a binder resin in a solvent. The charge-generating layer can also be formed by vapor deposition.

Examples of the binder resin for use in the monolayer photosensitive layer or the charge-generating layer include, but are not limited to, polycarbonates, polyesters, butyral resins, poly(vinyl acetal), acrylic resins, vinyl acetate resins, and urea resins. The binder resin can be a butyral resin. These binder resins may be used alone or in combination as a mixture or a copolymer.

Examples of the solvent for use in the coating liquid for the monolayer photosensitive layer or the coating liquid for the charge-generating layer include, but are not limited to, alcohol solvents, sulfoxide solvents, ketone solvents, ether solvents, ester solvents, and aromatic hydrocarbon solvents. These solvents may be used alone or in combination.

The charge-generating substance content of the monolayer photosensitive layer preferably ranges from 3 to 30 mass % of the total mass of the photosensitive layer. The charge-transport substance content preferably ranges from 30 to 70 mass % of the total mass of the photosensitive layer. The monolayer photosensitive layer preferably has a thickness in the range of 5 to 40 μm, more preferably 10 to 30 μm.

The charge-generating substance content of the multilayer photosensitive layer preferably ranges from 20 to 90 mass %, more preferably 50 to 80 mass %, of the total mass of the charge-generating layer. The charge-generating layer preferably has a thickness in the range of 0.01 to 10 μm, more preferably 0.1 to 3 μm.

A phthalocyanine crystal containing a urea compound within the crystal used as a charge-generating substance in the present invention can be used in combination with another charge-generating substance. In this case, the amount of phthalocyanine crystal containing a urea compound within the crystal is preferably 50 mass % or more of all the charge-generating substances.

[Charge-Transport Layer] The charge-transport layer can be formed by applying a coating liquid for the charge-transport layer to form a coating film and drying the coating film. The coating liquid for the charge-transport layer can be prepared by dissolving a charge-transport substance and a binder resin in a solvent.

Examples of the charge-transport substance include, but are not limited to, triarylamlne compounds, hydrazone compounds, stilbene compounds, pyrazoline compounds, oxazole compounds, thiazole compounds, and triallylmethane compounds.

Examples of the binder resin for use in the charge-transport layer include, but are not limited to, polyesters, acrylic resins, polyvinylcarbazole, phenoxy resins, polycarbonates, poly(vinyl butyral), polystyrene, poly(vinyl acetate), polysulfone, polyarylates, poly(vinylidene chloride), acrylonitrile copolymers, and poly(vinyl benzal).

The charge-transport substance content preferably ranges from 20 to 80 mass %, more preferably 30 to 70 mass %, of the total mass of the charge-transport layer. The charge-transport layer preferably has a thickness in the range of 5 to 40 μm, more preferably 10 to 30 μm.

The photosensitive layer can be applied by dipping, spray coating, spinner coating, bead coating, blade coating, or beam coating.

If necessary, a protective layer may be formed on the photosensitive layer. The protective layer can be formed by applying a coating liquid for the protective layer to form a coating film and drying the coating film. The coating liquid for the protective layer can be prepared by dissolving a binder resin in a solvent. Examples of the binder resin include, but are not limited to, poly(vinyl butyral), polyesters, polycarbonates (such as polycarbonate Z and modified polycarbonates), nylons, polyimides, polyarylates, polyurethanes, styrene-butadiene copolymers, styrene-acrylic acid copolymers, and styrene-acrylonitrile copolymers.

The protective layer may be formed by curing a monomer having charge transport ability (hole transport ability) through a polymerization reaction or a cross-linking reaction so as to have charge transport ability. More specifically, the protective layer can be formed by polymerizing or cross-linking a charge-transport compound (hole-transport compound) having a chain polymerizable functional group.

The protective layer preferably has a thickness in the range of 0.05 to 20 μm. The protective layer may contain conductive particles and/or an ultraviolet absorber. Examples of the conductive particles include, but are not limited to, metal oxide particles, such as tin oxide particles.

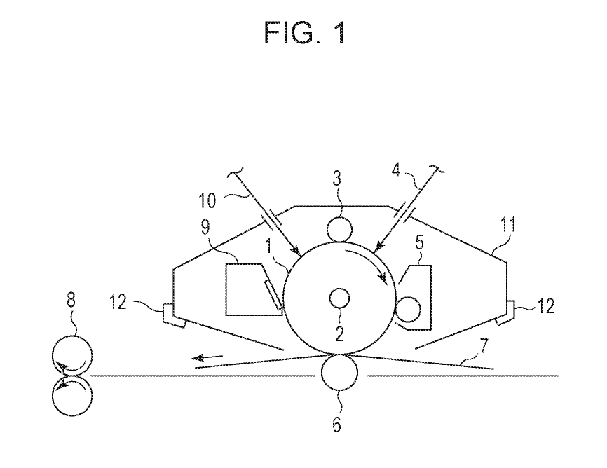

FIG. 1 illustrates an electrophotographic apparatus that includes a process cartridge including an electrophotographic photosensitive member.

In FIG. 1, a cylindrical (drum-type) electrophotographic photosensitive member 1 is rotated around a shaft 2 in the direction of the arrow at a predetermined circumferential velocity (process speed). The surface of the electrophotographic photosensitive member 1 is charged to a predetermined positive or negative potential using a charging unit 3 during the rotation of the electrophotographic photosensitive member 1. The charged surface of the electrophotographic photosensitive member 1 is then irradiated with image exposure light 4 emitted from an image exposure unit (not shown), and an electrostatic latent image is formed on the surface of the electrophotographic photosensitive member 1 in response to the intended image information. The image exposure light 4 is intensity-modulated light emitted from an image exposure unit, such as a slit exposure or laser beam scanning exposure unit, in response to the time-series electric digital image signals of the intended image information.

The electrostatic latent image formed on the surface of the electrophotographic photosensitive member 1 is developed with a developer (toner) contained in a developing unit 5 (normal development or reversal development) to form a toner image on the surface of the electrophotographic photosensitive member 1. The toner image formed on the surface of the electrophotographic photosensitive member 1 is transferred to a transferring member 7 with a transferring unit 6. A bias voltage (transfer bias) having polarity opposite to the polarity of the electric charges of the toner is applied to the transferring unit 6 with a bias power supply (not shown). The transferring member 7 is fed from a transferring member supply unit (not shown) to a contact portion between the electrophotographic photosensitive member 1 and the transferring unit 6 in synchronism with the rotation of the electrophotographic photosensitive member 1.

The transferring member 7 to which the toner image is transferred is then separated from the surface of the electrophotographic photosensitive member 1 and is transported to a fixing unit 8. After the toner image is fixed, the transferring member 7 is outputted from the electrophotographic apparatus as an image-formed article (such as a print or a copy).

After the toner image is transferred to the transferring member 7, the surface of the electrophotographic photosensitive member 1 is cleaned by removing deposits, such as the remaining developer (residual toner), with a cleaning unit 9. The residual toner may be recovered with the developing unit 5 (a cleaner-less system).

The electrophotographic photosensitive member 1 is again used for image forming after electric charges on the surface thereof are removed with pre-exposure light 10 emitted from a pre-exposure unit (not shown). In the case where the charging unit 3 is a contact charging unit, such as a charging roller, as illustrated in FIG. 1, the pre-exposure unit is not necessarily required.

In the present invention, two or more units of the electrophotographic photosensitive member 1, the charging unit 3, the developing unit 5, and the cleaning unit 9 may be integrally supported in a container and form a process cartridge. The process cartridge can be detachably attachable to the main body of the electrophotographic apparatus. For example, the electrophotographic photosensitive member 1 and at least one unit selected from the charging unit 3, the developing unit 5, and the cleaning unit 9 are integrally supported and form a cartridge. A process cartridge 11 can be detachably attached to the main body of the electrophotographic apparatus through a guide unit 12, such as a rail, for the main body of the electrophotographic apparatus.

In the case where the electrophotographic apparatus is a copying machine or a printer, the image exposure light 4 may be light reflected from an original document or light passing through an original document. The image exposure light 4 may also be light emitted by laser beam scanning, LED array driving, or liquid crystal shutter array driving in response to signals produced by reading an original document with a sensor.

### EXAMPLES

The present invention will be further described in the following examples. The present invention is not limited to these examples. The thickness of each layer of an electrophotographic photosensitive member according to examples and comparative examples was measured with an eddy current thickness gauge (Fischerscope, manufactured by Fischer Instruments K.K.) or was determined from the mass per unit area on a specific gravity basis.

### Example 1-1

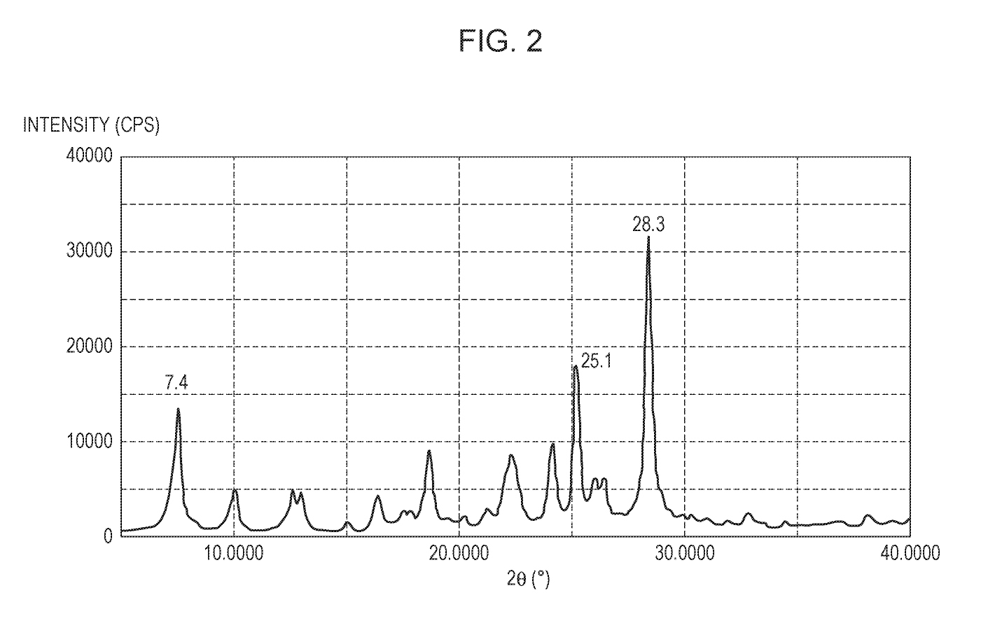

A hydroxygallium phthalocyanine was prepared in the same manner as in (Synthesis Example 1) and (Example 1-1) described in Japanese Patent Laid-Open No. 2011-94101. 0.5 parts of the hydroxygalliam phthalocyanine, 0.5 parts of an exemplary compound (1) (product code: D0712, manufactured by Tokyo Chemical Industry Co., Ltd.), and 9.5 parts of N,N-dimethylformamide were milled in a ball mill with 15 parts of glass beads having a diameter of 0.8 mm at room temperature (23° C.) for 52 hours. Hydroxygallium phthalocyanine crystals were extracted from the dispersion liquid with N,N-dimethylformamide and were filtered off. The filter was sufficiently washed with N,N-dimethylformamide and then with tetrahydrofuran. The filter residue was dried under vacuum to yield 0.43 parts of hydroxygallium phthalocyanine crystals. FIG. 2 shows an X-ray powder diffraction pattern of the hydroxygallium phthalocyanine crystals.

On the basis of the proton ratio in a NMR measurement, the exemplary compound (1) constituted 0.09 mass % of the phthalocyanine crystals, and N,N-dimethylformamide constituted 1.72 mass % of the phthalocyanine crystals. The exemplary compound (1) was solid but was soluble in N,N-dimethylformamide. Thus, the exemplary compound (1) was contained within the phthalocyanine crystals.

### Example 1-2

0.46 parts of hydroxygallium phthalocyanine crystals were prepared in the same manner as in Example 1-1 except that the amount of exemplary compound (1) was chanced from 0.5 parts to 1.0 part. The X-ray powder diffraction pattern of the hydroxygalliam phthalocyanine crystals was the same as that shown in FIG. 2.

A NMR measurement showed that the exemplary compound (1) constituted 0.18 mass % of the crystals, and N,N-dimethylformamide constituted 1.97 mass % of the crystals.

### Example 1-3

0.48 parts of hydroxygallium phthalocyanine crystals were prepared in the same manner as in Example 1-1 except that 0.5 parts of the exemplary compound (1) was replaced with 0.2 parts of the exemplary compound (7) prepared in the production example 2. The X-ray powder diffraction pattern of the hydroxygallium phthalocyanine crystals was the same as that shown in FIG. 2.

On the basis of the proton ratio in a NMR measurement, the exemplary compound (19) constituted 0.20 mass % of the phthalocyanine crystals, and N,N-dimethylformamide constituted 2.08 mass % of the phthalocyanine crystals. Since the exemplary compound (7) was solid and was poorly soluble in N,N-dimethylformamide, the exemplary compound (7) was subjected to a TO measurement. The TO measurement showed that the weight loss increased at temperatures of 450° C. or more, which are higher than the evaporation temperature (200° C. to 340° C.) of the exemplary compound (7) alone. This means that the exemplary compound (7) was contained within the phthalocyanine crystals.

### Example 1-4

0.45 parts of hydroxygallium phthalocyanine crystals were prepared in the same manner as in Example 1-1 except that 0.5 parts of the exemplary compound (1) was replaced with 0.2 parts of the exemplary compound (6) prepared in the production example 4. The X-ray powder diffraction pattern of the hydroxygallium phthalocyanine crystals was the same as that shown in FIG. 2.

On the basis of the proton ratio in a NMR measurement, the exemplary compound (17) constituted 0.05 mass % of the phthalocyanine crystals, and N,N-dimethylformamide constituted 2.11 mass % of the phthalocyanine crystals. Since the exemplary compound (6) was solid and was poorly soluble in N,N-dimethylformamide, the exemplary compound (6) was subjected to a TG measurement. The TG measurement showed that the weight loss increased at temperatures of 500° C. or more, which are higher than the evaporation temperature (200° C. to 341° C.) of the exemplary compound (6) alone. This means that the exemplary compound (6) was contained within the phthalocyanine crystals.

### Example 1-5

0.49 parts of hydroxygallium phthalocyanine crystals were prepared in the same manner as in Example 1-1 except that 0.5 parts of the exemplary compound (1) was replaced with 0.5 parts of the exemplary compound (2) (product code: D0485, manufactured by Tokyo Chemical Industry Co., Ltd.). The X-ray powder diffraction pattern of the hydroxygallium phthalocyanine crystals was the same as that shown in FIG. 2.

A NMR measurement showed that the exemplary compound (2) constituted 0.04 mass % of the crystals, and N,N-dimethylformamide constituted 2.35 mass % of the crystals. The exemplary compound (2) was solid but was soluble in N,N-dimethylformamide. Thus, the exemplary compound (2) was contained within the phthalocyanine crystals.

### Example 1-6

0.48 parts of hydroxygallium phthalocyanine crystals were prepared in the same manner as in Example 1-1 except that 0.5 parts of the exemplary compound was replaced with 0.5 parts of the exemplary compound (15) (product code: C0031, manufactured by Tokyo Chemical Industry Co., Ltd.). The X-ray powder diffraction pattern of the hydroxygallium phthalocyanine crystals was the same as that shown in FIG. 2.

A NMR measurement showed that the exemplary compound (15) constituted 1.48 mass % of the crystals, and N,N-dimethylformamide constituted 2.62 mass % of the crystals. The exemplary compound (15) was sold but was soluble in N,N-dimethylformamide. Thus, the exemplary compound (15) was contained within the phthalocyanine crystals.

### Example 1-7

0.45 parts of hydroxygallium phthalocyanine crystals were prepared in the same manner as in Example 1-1 except that 0.5 parts of the exemplary compound (1) was replaced with 0.5 parts of the exemplary compound (22) (product code: T0197, manufactured by Tokyo Chemical Industry Co., Ltd.). The X-ray powder diffraction pattern of the hydroxygallium phthalocyanine crystals was the same as that shown in FIG. 2.

A NMR measurement showed that the exemplary compound (22) constituted 0.44 mass % of the crystals, and N,N-dimethylformamide constituted 2.62 mass % of the crystals. The exemplary compound (22) was solid but was soluble in N,N-dimethylformamide. Thus, the exemplary compound (22) was contained within the phthalocyanine crystals.

### Example 1-8

0.39 parts of hydroxygallium phthalocyanine crystals were prepared in the same manner as in Example 1-1 except that N,N-dimethylformamide was replaced with N-methylformamide. FIG. 3 shows an X-ray powder diffraction pattern of the hydroxygallium phthalocyanine crystals.

A NMR measurement showed that the exemplary compound (1) constituted 1.66 mass % of the crystals, and N-methylformamide constituted 1.75 mass % of the crystals. The exemplary compound (1) was solid but was soluble in N-methylformamide. Thus, the exemplary compound (1) was contained within the phthalocyanine crystals.

### Comparative Example 1-1

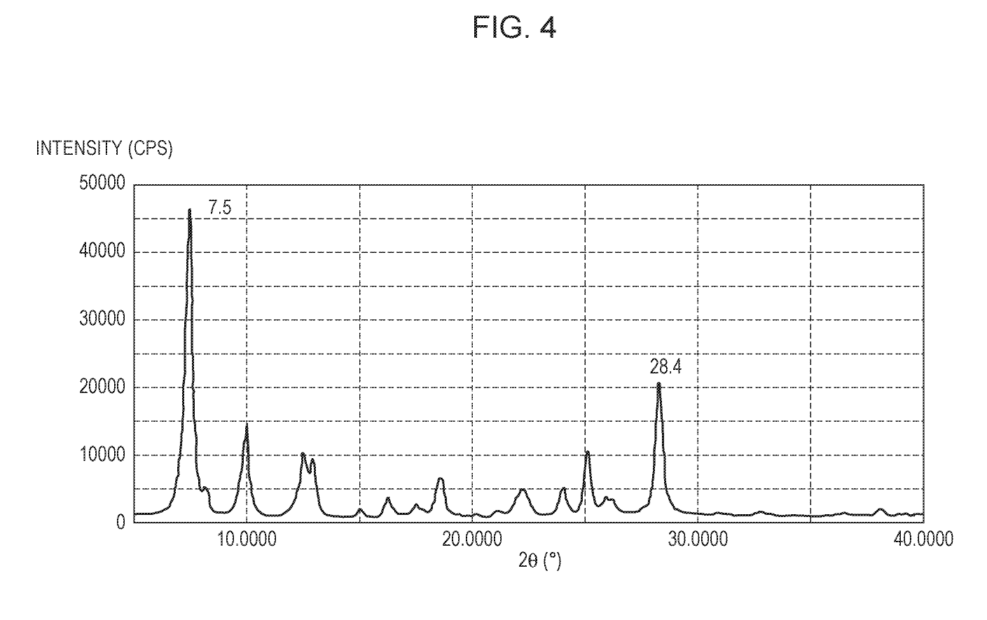

0.44 parts of hydroxygallium phthalocyanine crystals were prepared in the same manner as in Example 1-1 except that 0.5 parts of the exemplary compound (1) was not added. FIG. 4 shows an X-ray powder diffraction pattern of the hydroxygallium phthalocyanine crystals.

### Comparative Example 1-2

0.48 parts of hydroxygallium phthalocyanine crystals were prepared in the same manner as in Example 1-1 except that 0.5 parts of the exemplary compound (1) was replaced with 0.5 parts of tetramethylurea (product code: T0158, manufactured by Tokyo Chemical Industry Co., Ltd.).

### Comparative Example 1-3

0.48 parts of hydroxygallium phthalocyanine crystals were prepared in the same manner as in Example 1-1 except that 0.5 parts of the exemplary compound (1) was replaced with 0.5 parts of 1,3-dimethyl-2-imidazolidinone (product code: D1477, manufactured by Tokyo Chemical Industry Co., Ltd.).

### Example 2-1

60 parts of barium sulfate particles coated with tin oxide (trade name: Passtran PC1, manufactured by Mitsui Mining & Smelting Co., Ltd.), 15 parts of titanium oxide particles (trade name: TITANIX JR, manufactured by Tayca Corp.), 43 parts of a resole phenolic resin (trade name: Phenolite J-325, manufactured by DIC Corp., solid content 70 mass %), 0.015 parts of a silicone oil (trade name: SH28PA, manufactured by Dow Corning Toray Co., Ltd.), 3.6 parts of a silicone resin (trade name: Tospearl 120, manufactured by Momentive Performance Materials Inc.), 50 parts of 2-methoxy-1-propanol, and 50 parts of methanol were dispersed in a ball mill for 20 hours to prepare a coating liquid for a conductive layer.

The coating liquid for a conductive layer was applied to an aluminum cylinder support (having a diameter of 24 mm) by dip coating and was dried at 140° C. for 30 minutes. The resulting conductive layer had a thickness of 15 μm.

10 parts of a copolymerized nylon resin (trade name: Amilan CM8000, manufactured by Toray industries, Inc.) and 30 parts of a methoxymethylated 6 nylon resin (trade name: Toresin EF-30T, manufactured by Nagase ChemteX Corp.) were dissolved in a mixed solvent of 400 parts of methanol and 200 parts of n-butanol to prepare a coating liquid for an undercoat layer.

The coating liquid for an undercoat layer was applied to the conductive layer by dip coating and was dried to form an undercoat layer having a thickness of 0.5 μm.

10 parts of hydroxygallium phthalocyanine crystals (a charge-generating substance) prepared in Example 1-1, 5 parts of poly(vinyl butyral) (trade name: S-Lec BX-1, manufactured by Sekisui Chemical Co., Ltd.), and 250 parts of cyclohexanone were mixed. The mixture was dispersed in a sand mill using glass beads having a diameter of 1 mm for 4 hours to prepare a dispersion liquid. The dispersion liquid was diluted with 250 parts of ethyl acetate to prepare a coating liquid for a charge-generating layer.

The coating liquid for a charge-generating layer was applied to the undercoat layer by dip coating and was dried at 100° C. for 10 minutes to form a charge-generating layer having a thickness of 0.16 μm.

8 parts of a compound (a charge-transport substance) represented by the following formula (3) and 10 parts of a polycarbonate (trade name: Iupilon Z-200, Mitsubishi Gas Chemical Co., Inc.) were dissolved in 70 parts of monochlorobenzene to prepare a coating liquid for a charge-transport layer.

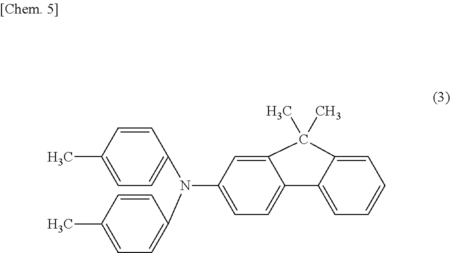 [SMILES: Cc1ccc(N(c2ccc(C)cc2)c2ccc3c(c2)C(C)(C)c2ccccc2-3)cc1]

The coating liquid for a charge-transport layer was applied to the charge-generating layer by dip coating and was dried at 110° C. for one hour to form a charge-transport layer having a thickness of 23 μm.

Thus, a cylindrical (drum-type) electrophotographic photosensitive member according to Example 2-1 was completed.

### Examples 2-2 to 2-8

Electrophotographic photosensitive members according to Examples 2-2 to 2-8 were manufactured in the same manner as in Example 2-1 except that the hydroxygallium phthalocyanine crystals used in the preparation of the coating liquid for a charge-generating layer were replaced with the hydroxygallium phthalocyanine crystals prepared in Examples 1-2 to 1-8.

### Comparative Examples 2-1 to 2-3

Electrophotographic photosensitive members according to Comparative Examples 2-1 to 2-3 were manufactured in the same manner as in Example 2-1 except that the hydroxygallium phthalocyanine crystals used in the preparation of the coating liquid for a charge generating layer were replaced with the hydroxygallium phthalocyanine crystals prepared in Comparative Examples 1-1 to 1-3.

### Comparative Example 2-4

An electrophotographic photosensitive member according to Comparative Example 2-4 was manufactured in the same manner as in Example 2-1 except that the hydroxygallium phthalocyanine crystals used in the preparation of the coating liquid for a charge-generating layer were replaced with 10 parts of the hydroxygallium phthalocyanine crystals prepared in Comparative Example 1-1, and 1 part of the exemplary compound (1) was added in the preparation of the coating liquid for a charge-generating layer.

### Comparative Example 2-5

An electrophotographic photosensitive member according to Comparative Example 2-5 was manufactured in the same manner as in Example 2-1 except that the hydroxygallium phthalocyanine crystals used in the preparation of the coating liquid for a charge-generating layer were replaced with 10 parts of the hydroxygallium phthalocyanine crystals prepared in Comparative Example 1-1, and 0.1 parts of the exemplary compound (1) was added in the preparation of the coating liquid for a charge-generating layer.

### Evaluation of Examples 2-1 to 2-8 and Comparative Examples 2-1 to 2-5

The electrophotographic photosensitive members according to Examples 2-1 to 2-8 and Comparative Examples 2-1 to 2-5 were subjected to the evaluation of ghost images.

A laser-beam printer manufactured by Hewlett-Packard Japan, Ltd. (trade name: Color Laser Jet CP3525dn) was used as an electrophotographic apparatus for the evaluation after the following modifications. Pre-exposure light was not used, and the charging conditions and image light exposure could be changed. Each of the manufactured electrophotographic photosensitive members was mounted in a cyan process cartridge. The cyan process cartridge was mounted in a process cartridge station. The printer could be operated without another process cartridge to be mounted in the main body of the printer.

For the output of images, only a cyan process cartridge was mounted in the main body, and monochrome images formed of a cyan toner alone were outputted.

First, in a normal temperature and normal humidity environment at a temperature of 23° C. and at a humidity of 55% RH, the charging conditions and image light exposure were adjusted such that the initial dark area potential was −500 V, and the initial light area potential was −100 V. When the surface potential of the drum-type electrophotographic photosensitive member was measured in order to set the electric potentials, the cartridge was modified such that a potential probe (trade name: model 6000B-8, manufactured by Trek Japan) was disposed at the position of development. The electric potential of the central portion of the cylindrical electrophotographic photosensitive member was measured with an electrostatic voltmeter (trade name: model 344, manufactured by Trek Japan).

The evaluation of ghost images was then performed under the conditions as described above. A continuous 1000-sheet feeding test was performed. Ghost images were evaluated immediately after the continuous sheet feeding test and 15 hours after the continuous sheet feeding test. Table 2 shows the evaluation results in a normal temperature and normal humidity environment.

The electrophotographic photosensitive member and the electrophotographic apparatus for the evaluation were left to stand in a low temperature and low humidity environment at a temperature of 15° C. and at a humidity of 10% RH for 3 days. After that ghost images were evaluated. A continuous 1000-sheet feeding test was performed under the conditions described above. Ghost images were evaluated immediately after the continuous sheet feeding test and 15 hours after the continuous sheet feeding test. Table 2 also shows the evaluation results in a low temperature and low humidity environment.

In the continuous sneer feeding test, a character was printed in a single color of cyan on an AA-size plain paper sheet at a printing ratio of 1%.

Ghost images were evaluated using the following method. In the evaluation of host images, after a solid white image was first outputted, four different ghost charts were outputted. A solid black image was then outputted, and four ghost charts were again outputted. After the images were outputted in this order, the eight ghost images were evaluated. In the ghost charts, four solid black squares of 25 mm square arranged in parallel to each other at evenly spaced intervals were printed on a solid white background in an area of 30 mm from the beginning of the output image (10 mm from the upper end of the sheet), and four halftone printed patterns were printed in an area of more than 30 mm from the beginning of the output image. The following four ghost charts were rated.

The four ghost charts were only different in the halftone pattern in the area of more than 30 mm from the beginning of the output image. The four halftone patterns were as follows:

(1) horizontal* 1 dot, single-space print (laser exposure) pattern,

(2) horizontal* 2 dots, double-space print (laser exposure) pattern,

(3) horizontal* 2 dots, triple-space print (laser exposure) pattern, and

(4) Keima-knight print (laser exposure) pattern (2 dots in 6 squares similar to a knight-jump pattern in shogi (a Japanese board game resembling chess). *: “Horizontal” means the scanning direction of the laser scanner (a horizontal direction in the outputted sheet).

The following are visual ratings of the ghost images. Levels 4, 5, and 6 lack the advantages of the present invention.

Level 1: No ghost was observed in any of the ghost charts.

Level 2: A ghost was slightly observed in at least one of the ghost charts.

Level 3: A ghost was slightly observed in all the ghost charts.

Level 4: A ghost was observed in at least one of the Ghost charts.

Level 5: A ghost was observed in all the ghost charts.

Level 6: A ghost was clearly observed in at least one of the ghost charts.

TABLE 2

| | Ghost level | | | | | |
|---|---|---|---|---|---|---|
| | Normal temperature and normal | | | Low temperature and low humidity | | |
| | humidity environment | | | environment | | |
| | | Immediately | 15 hours after | | Immediately | 15 hours after |
| | | after continuous | continuous | | after continuous | continuous |
| | Initial | sheet feeding | sheet feeding | Initial | sheet feeding | sheet feeding |
| Example 2-1 | 1 | 1 | 1 | 1 | 2 | 2 |
| Example 2-2 | 1 | 1 | 1 | 1 | 2 | 2 |
| Example 2-3 | 1 | 2 | 2 | 1 | 2 | 2 |
| Example 2-4 | 1 | 2 | 2 | 2 | 3 | 2 |
| Example 2-5 | 1 | 2 | 2 | 2 | 3 | 2 |
| Example 2-6 | 2 | 3 | 2 | 2 | 3 | 3 |
| Example 2-7 | 2 | 3 | 3 | 2 | 3 | 3 |
| Example 2-8 | 1 | 1 | 1 | 1 | 2 | 1 |
| Comparative | 4 | 5 | 4 | 5 | 6 | 5 |
| Example 2-1 | | | | | | |
| Comparative | 4 | 5 | 4 | 5 | 6 | 5 |
| Example 2-2 | | | | | | |
| Comparative | 4 | 5 | 5 | 5 | 6 | 6 |
| Example 2-3 | | | | | | |
| Comparative | 3 | 4 | 4 | 4 | 5 | 5 |
| Example 2-4 | | | | | | |
| Comparative | 4 | 5 | 4 | 5 | 6 | 5 |
| Example 2-5 | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-176518, filed Aug. 28, 2013, and No. 2014-146038, filed Jul. 16, 2014, which are hereby incorporated by reference herein in their entirety.

1. An electrophotographic photosensitive member comprising:
a support; and
a photosensitive layer formed on the support;
wherein the photosensitive layer comprises:
a phthalocyanine crystal in which an urea compound is contained,
wherein the urea compound has one or more urea moieties comprising:
a carbonyl group, or a thiocarbonyl group, and
two nitrogen atoms,
each of the two nitrogen atoms connects to a hydrogen atom, an alkyl group, an unsubstituted or substituted aryl group, or an unsubstituted or substituted arylene group, and
at least one of the nitrogen atoms connects to an unsubstituted or substituted aryl group.

2. The electrophotographic photosensitive member according to claim 1, wherein the urea compound is at least one selected from the group consisting of a compound represented by the following formula (1) and a compound represented by the following formula (2): 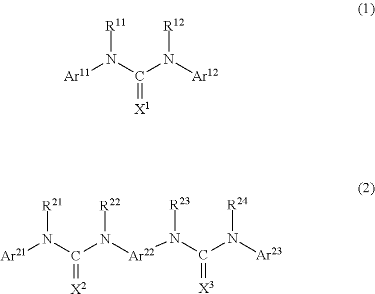
wherein R¹¹, R¹², and R²¹ to R²⁴ each independently represent a hydrogen atom or an alkyl group, X¹ to X³ each independently represent an oxygen atom or a sulfur atom, Ar²² represent an unsubstituted or substituted arylene group, Ar¹¹, Ar¹², Ar²¹, and Ar²³ each independently represent a hydrogen atom or an unsubstituted or substituted aryl group, at least one of Ar¹¹ and Ar¹² and at least one of Ar²¹ and Ar²³ each independently represent an unsubstituted or substituted aryl group,
a substituent of the substituted arylene group is an alkyl group, an alkoxy-substituted alkyl group, a halogen-substituted alkyl group, an alkoxy group, an alkoxy-substituted alkoxy group, a halogen-substituted alkoxy group, or a halogen atom, and
a substituent of the substituted aryl group is a cyano group, a dialkylamino group, a hydroxy group, an alkyl group, an alkoxy-substituted alkyl group, a halogen-substituted alkyl group, an alkoxy group, an alkoxy-substituted alkoxy group, a halogen-substituted alkoxy group, a nitro group, or a halogen atom.

3. The electrophotographic photosensitive member according to claim 2, wherein Ar²² in the formula (2) is a phenylene group.

4. The electrophotographic photosensitive member according to claim 2, wherein R¹¹, R¹², and R²¹ to R²⁴ in the formulae (1) and (2) each independently represent a methyl group, an ethyl group, or a propyl group.

5. The electrophotographic photosensitive member according to claim 2, wherein
Ar¹¹, Ar¹², Ar²¹, and Ar²³ in the formulae (1) and (2) each independently represent a substituted or unsubstituted phenyl group, and
a substituent of the substituted phenyl group is an alkyl group, an alkoxy group, a dialkylamino group, or a halogen atom.

6. The electrophotographic photosensitive member according to claim 5, wherein Ar¹¹, Ar¹², Ar²¹, and Ar²³ in the formulae (1) and (2) represent a phenyl group.

7. The electrophotographic photosensitive member according to claim 1, wherein the phthalocyanine crystal is a gallium phthalocyanine crystal.

8. The electrophotographic photosensitive member according to claim 7, wherein the gallium phthalocyanine crystal is a gallium phthalocyanine crystal in which N,N-dimethylformamide and/or N-methylformamide are contained.

9. The electrophotographic photosensitive member according to claim 7, wherein the gallium phthalocyanine crystal is a hydroxygallium phthalocyanine crystal.

10. The electrophotographic photosensitive member according to claim 9, wherein the hydroxygallium phthalocyanine crystal is a hydroxygallium phthalocyanine crystal having peaks at Bragg angles 2θ of 7.4±0.3 degrees and 28.3±0.3 degrees in X-ray diffraction using CuKα radiation.

11. The electrophotographic photosensitive member according to claim 1, wherein the urea compound content of the phthalocyanine crystal is 0.01 mass % or more and 3 mass % or less.

12. The electrophotographic photosensitive member according to claim 1, wherein
the photosensitive layer is a multilayer photosensitive layer comprising a charge-generating layer and a charge-transport layer formed on the charge-generating layer, and
the charge-generating layer comprises a phthalocyanine crystal in which is contained the urea compound.

13. A process cartridge detachably attachable to a main body of an electrophotographic apparatus, wherein the process cartridge integrally supports:
the electrophotographic photosensitive member according to claim 1, and
at least one unit selected from the group consisting of a charging unit, a developing unit, and a cleaning unit.

14. An electrophotographic apparatus, comprising:
the electrophotographic photosensitive member according to claim 1;
a charging unit;
an exposure unit;
a developing unit; and
a transferring unit.

15. A phthalocyanine crystal in which a urea compound is contained,
wherein the urea compound has one or more urea moieties comprising:
a carbonyl group, or a thiocarbonyl group, and
two nitrogen atoms,
each of the two nitrogen atoms connects to a hydrogen atom, an alkyl group, an unsubstituted or substituted aryl group, or an unsubstituted or substituted arylene group, and
at least one of the nitrogen atoms connects to an unsubstituted or substituted aryl group.

16. The phthalocyanine crystal according to claim 15, wherein the urea compound is at least one selected from the group consisting of compounds represented by the following formula (1) and compounds represented by the following formula (2): 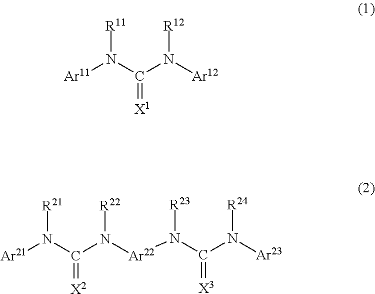
wherein R¹¹, R¹², and R²¹ to R²⁴ each independently represent a hydrogen atom or an alkyl group, X¹ to X³ each independently represent an oxygen atom or a sulfur atom, Ar²² represent an unsubstituted or substituted arylene group, Ar¹¹, Ar¹², Ar²¹, and Ar²³ each independently represent a hydrogen atom or an unsubstituted or substituted aryl group, at least one of Ar¹¹ and Ar¹² and at least one of Ar²¹ and Ar²³ each independently represent an unsubstituted or substituted aryl group,
a substituent of the substituted arylene group is an alkyl group, an alkoxy-substituted alkyl group, a halogen-substituted alkyl group, an alkoxy group, an alkoxy-substituted alkoxy group, a halogen-substituted alkoxy group, or a halogen atom, and
a substituent of the substituted aryl group is a cyano group, a dialkylamino group, a hydroxy group, an alkyl group, an alkoxy-substituted alkyl group, a halogen-substituted alkyl group, an alkoxy group, an alkoxy-substituted alkoxy group, a halogen-substituted alkoxy group, a nitro group, or a halogen atom.
